(19) United States
(12) Patent Application Publication
(10) Pub. No.: US 2021/0158244 A1
(43) Pub. Date: May 27, 2021

(54) METHOD FOR TAMPER-PROOF OPERATION OF FIELD DEVICES IN AUTOMATION ENGINEERING

(71) Applicant: Endress+Hauser Conducta GmbH+Co. KG, Gerlingen (DE)

(72) Inventors: Thomas Alber, Stuttgart (DE); Markus Kilian, Merzhausen (DE); Axel Pöschmann, Basel (CH); Sascha Bihler, Rheinfelden (DE); Simon Merklin, Bahlingen a.K. (DE)

(21) Appl. No.: 17/104,508

(22) Filed: Nov. 25, 2020

(30) Foreign Application Priority Data
Nov. 25, 2019 (DE) 10 2019 131 860.2

(51) Int. Cl. G06Q 10/06; G06F 21/31

(52) U.S. Cl. CPC G06Q 10/06311; G06Q 10/063114; G06F 21/31

(57) ABSTRACT

The present disclosure relates to a method for tamper-proof operation of a field device in automation engineering, comprising: creating an order ticket via or using an order management system, wherein the order ticket contains data authorizing a defined service technician to perform a defined work order on a defined field device, transmitting the order ticket to the defined field device, logging-in of the defined service technician to the defined field device by means of the order ticket or by additional input of authentication data, checking the order ticket or the authentication data by means of the field device, if the check is positive, authorization is given to perform the defined work order, performing of the defined work order by the defined service technician on the defined field device, and automatic creation of a confirmation ticket relating to the defined work order or its performance on the defined field device.

### CROSS-REFERENCE TO RELATED APPLICATION

The present application is related to and claims the priority benefit of German Patent Application No. 10 2019 131 860.2, filed on Nov. 25, 2019, the entire contents of which are incorporated herein by reference.

### TECHNICAL FIELD

The present disclosure relates to a method for tamper-proof operation of field devices in automation engineering.

### BACKGROUND

Field devices for detecting or influencing physical, chemical, or biological process variables are often used in process automation as well as in manufacturing automation. Measuring devices are used for detecting process variables. These measuring devices are used, for example, for pressure and temperature measurement, conductivity measurement, flow measurement, pH measurement, fill level measurement, etc., and detect the corresponding process variables of pressure, temperature, conductivity, pH value, fill level, flow, etc. Actuator systems are used for influencing process variables. Examples of actuators are pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level. Field devices are, generally speaking, devices which are used in the vicinity of the process or of the plant and which supply or process information relevant to process or plant.

If a field device is to be serviced or repaired, a service technician receives an appropriate work order. The work order is handed over by hand or it reaches the service technician via a suitable system, for example an asset management system or an ERP system. However, the system may well still be a card index box as well.

Each field device in automation engineering usually has a permanently available access (an access interface) via which the field device can be operated. The term “operation of the field device” in connection with the present disclosure is to be interpreted broadly. The operation may thus be a function test, a parameterization or calibration process, or a repair or an exchange of the field device. However, the operation of the field device may also include augmenting a parameter, installing a software/firmware update, or simply displaying desired information from the field device. A service technician uses this access to perform the work order. After completion of the work order, the access to the field device remains unchanged.

After a service employee, or generally speaking a user, has completed the work order, the performance of the work order is documented on paper or electronically. Ideally, this documentation is then reported back/fed back by the user into the system, via which the work order reached the user, and is archived in the system.

The permanent access to the field device can be protected via user administration or access control. In many cases, however, the permanent access to the field devices is completely unprotected.

Consider the case where access to a field device with user management or access control is permanently available. If the user has access authorization, he can operate the field device without restriction. Authorization to perform a single specific work order does not exist. Consequently, it is possible for each authorized user to, inadvertently or intentionally, adjust or manipulate the field device further, even beyond the scope of the actual work order.

If the user lacks the access authorization for a field device, the corresponding work order cannot be performed. In this case, access authorization for the corresponding field device or the corresponding field devices must first be established for the user. Optionally, the access authorization must be deleted again after performance of the work order. This means an increased workload, as a result of which the performance of the work order is certainly delayed.

Moreover, errors may also occur during the performance of the work order. For example, errors may include: the user performing the work order on the wrong field device; the user selecting the right field device but performing the wrong work order on the right field device; following completion of the work order, the documentation is incorrect; following completion of the work order, the documentation is transferred into the system incorrectly or it is accepted incorrectly by the system; the work order is not documented at all; the work order is documented even though the work order was not performed at all; and forgetting to delete an access authorization granted to perform a work order constitutes a further safety risk.

The aim of the present disclosure is to provide a method which ensures that a defined work order is carried out in a tamper-proof manner on a field device in automation engineering.

### SUMMARY

The object is achieved by a method for tamper-proof operation of field devices in automation engineering, comprising the following method steps: creating an order ticket using an order management system, wherein the order ticket contains data authorizing a defined service technician to perform a defined work order on a defined field device; transmitting the order ticket to the defined field device; logging-in of the defined service technician to the defined field device by means of the order ticket or/and by additional input of authentication data; checking the order ticket or/and the authentication data by means of the field device; if the check is positive, authorization is given to perform the defined work order, performing of the defined work order by the defined service technician on the defined field device; and automatic creation of a confirmation ticket relating to the defined work order or its performance on the field device.

The order ticket includes or corresponds to a transaction. A transaction is a sequence of program steps that are considered a logical unit because they leave the data set in a consistent state after error-free and complete execution. Therefore, a transaction is required to be executed either completely and free of errors or not at all.

In other words, the method includes the following method steps: an order ticket is created automatically or electronically; order data for the work order to be performed are defined in the order ticket; the order data may, for example, be the following data: unique identifier of the service employee or of the user, of the field device, of the work order, e.g., maintenance task, unlocking of a defined parameter, calibration, exchange of the field device, etc., and optionally of the time period in which the work order is to be performed.

The following aspect is also advantageous: field devices have orderable product features (software features). These days, they are unlocked or executed/activated by inputting a code. Using the present disclosure, it is now possible for the unlocking to be included in the order data of the order ticket. Accordingly, corresponding product features of the field devices can be safely activated or deactivated in a simple manner.

The order ticket is transmitted to the field device via an arbitrary data transmission channel, for example manually, via an operating tool, via a wireless or wired network, or it is stored on a storage medium, for example a USB stick, and is transmitted by the service technician to the field device.

The field device can be logged into by inputting secure login information into the field device. However, the login can also take place, as will be explained in more detail below, by using an authorized device, an operating tool or an authorization tool. Furthermore, it is provided that the user is automatically authorized to perform the work order by conveying the order ticket to the field device. In this case, it is therefore provided that the order ticket already contains the access authorization to the field device. The order ticket thus serves as an identifier (e.g., name of the user) and as an authenticator (e.g., contains a password or password equivalent for direct access to the field device) and furthermore includes the authorization to operate the field device according to the work order. By using a password equivalent instead of a password, the real password does not have to be revealed. The password may also only be valid for a limited time. If the operator or service technician thus conveys the order ticket to the field device, the login data which authorize the performance of the defined work order are automatically transmitted to the field device thereby.

The user performs the work order. The performance of the work order is documented in the field device. Once the order has been performed, the order ticket is automatically invalidated. Optionally, a confirmation ticket may be generated which is transmitted back to the order management system and which may contain, for example, the following information: Reference to the order data or a copy of the order data, documentation of the performed settings/work, working time, etc.

The method according to the present disclosure ensures that the work order is performed according to the order data specified in the order ticket (e.g., service employee, field device, work order, etc.). This increases both the field device safety and the plant safety as well as the availability thereof. Where required, the optional confirmation ticket allows invoicing and documentation requiring proof to preferably be done automatically. The performance of the defined work order is documented via the confirmation ticket.

Furthermore, it is to be considered advantageous that the operator's plant password does not have to be disclosed for access to the field device. This applies even if the work order is performed externally, i.e., if the field device is returned to the manufacturer for maintenance or repair. In addition, the single use of the order ticket ensures at all times that access to the field device is only granted to an authorized user.

In summary, it can be said that the method according to the present disclosure is further developed by the following method step: storage of the following order-related data identifying the work order in the order ticket: unique identifier of the service technician or of an authentication medium (badge, smart card, smartphone, . . . ) to be used by the service technician; unique identifier of the field device to be operated, e.g., via the serial number of the manufacturer or of the plant operator; and specification of the work order to be performed (read or write access). By way of example, the work order includes, for example, the control, maintenance, unlocking of at least one parameter, calibration, field device exchange or component exchange; and, optionally, specification of the time period in which the work order is to be performed.

An advantageous development of the method according to the present disclosure describes a plurality of variants for how the order ticket can be transmitted to the defined field device: manual transmission of the order ticket to the defined field device, e.g., via an interface on the defined field device; transmission of the order ticket to the defined field device by means of the authentication medium or a storage medium; and transmission of the order ticket to the defined field device via a wireless or wired network, e.g., a field bus, into which the field device is integrated.

A preferred embodiment of the method according to the present disclosure comprises the following method step: logging-in of the service technician to the defined field device by transmitting the order ticket to the defined field device, wherein the access authorization for performing the defined order on the defined field device is contained in the order ticket.

It is furthermore provided that the order ticket automatically becomes invalid after the defined work order has been performed once on the defined field device. It therefore cannot be used for performing further work orders.

In order to document the performance of a work order on a defined field device, a corresponding confirmation ticket is automatically generated based on the inputs of the service technician. The confirmation ticket is transmitted to the order management system.

Moreover, the method according to the present disclosure is further developed by the following method step: listing of at least two of the identifiers not mentioned exhaustively below relating to the performance of the defined work order in the confirmation ticket: reference to the order data of the order ticket or copy of the order data of the order ticket; unique identifier of the service technician who executed the work order; documentation of the performed work or documentation of the settings configured on the defined field device, and time duration for handling the order.

In order to ensure that the data cannot be manipulated by hacking attacks, provision is made for the order ticket or the confirmation ticket to be secured cryptographically, for example by means of encryption or the use of a signature. This subsequently allows unsecured transmission of the tickets. The cryptographic protection also precludes tickets from being created by an unauthorized order creation system.

### BRIEF DESCRIPTION OF THE DRAWING

The present disclosure is explained in greater detail with reference to the following FIGURES.

FIG. 1 shows a schematic representation illustrating the method according to the present disclosure for tamper-proof operation of a field device FG in automation engineering.

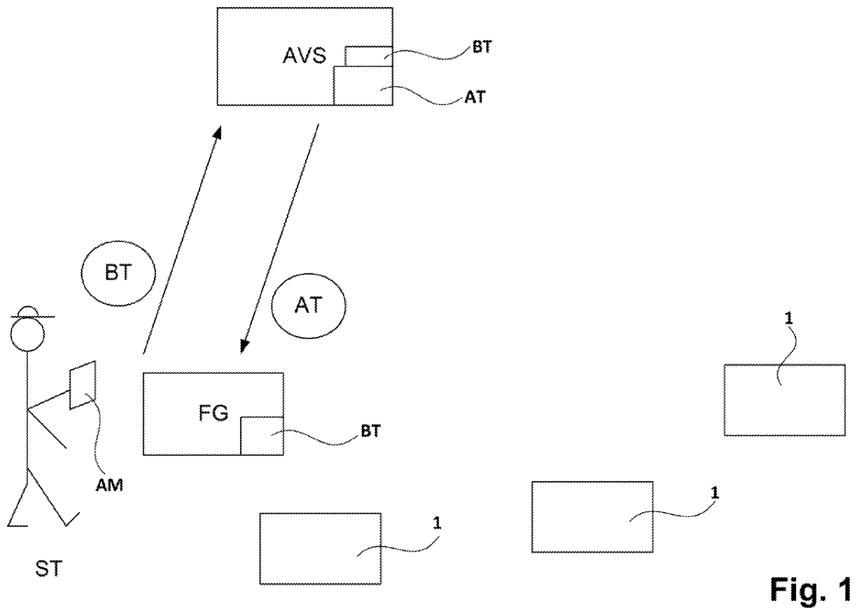

### DETAILED DESCRIPTION

A plurality of field devices 1 is arranged in a process plant, for example, said field devices controlling or monitoring an industrial process or an automation system, for example. Consider the case in which one of the field devices FG is to be checked because it is supplying abnormal measured values, for example, which may suggest a possible malfunction.

A corresponding order ticket AT is created via an order management system AVS. The order ticket AT contains clear instructions as to which operator or which service technician with which qualification or with which specialist knowledge is authorized to perform which work order at which field device FG, if applicable, in which time period. Alternatively, the order ticket contains clear instructions as to which authentication medium AM (badge, smart card, smartphone, plant operator's specialist tool, etc.) is to be used by a service technician ST.

The order ticket AT is transmitted to the defined field device FG. The service technician ST logs into the defined field device FG, preferably by means of the order ticket AT. However, it is alternatively also possible for the service technician ST to log in via the additional input of authentication data.

The field device FG checks the order ticket AT or/and the authentication data. If the check is positive, the service technician ST receives authorization to perform the clearly defined work order. The work order may be one or more of the activities not mentioned exhaustively below: control, maintenance, unlocking of at least one parameter, calibration, exchange of a component of the field device, exchange of the field device. Depending on the work order, the service technician ST receives read or write access to the field device.

Subsequently, the defined work order is carried out by the defined service technician ST on the defined field device FG. After the defined work order has been performed once on the defined field device FG, the order ticket AT becomes invalid; it expires. The automatic creation of a confirmation ticket BT relating to the defined work order or its performance on the defined field device FG follows. The documentation of the performed work contained in the confirmation ticket BT or the documentation of the settings configured on the defined field device FG as well as the time duration for handling the work order is stored in the order management system AVS.

1. A method for tamper-proof operation of a field device in automation engineering, comprising the following method steps:
creating an order ticket via or using an order management system, wherein the order ticket contains data authorizing a defined service technician to perform a defined work order on a defined field device,
transmitting the order ticket to the defined field device,
logging-in of the defined service technician to the defined field device by means of the order ticket or by additional input of authentication data,
checking the order ticket or the authentication data by means of the field device,
if the check is positive, authorization is given to perform the defined work order,
performing of the defined work order by the defined service technician on the defined field device,
automatic creation of a confirmation ticket relating to the defined work order or its performance on the defined field device.

2. The method of claim 1, comprising the following method step:
storage of the following order-related data identifying the work order in the order ticket: unique identifier of the service technician or of an authentication medium to be used by the service technician, unique identifier of the field device to be operated, specification of the work order to be performed.

3. The method of claim 1, comprising one of the following method steps:
transmitting the order ticket to the defined field device using one of the alternatives given below:
manual transmission of the order ticket to the defined field device,
transmission of the order ticket to the defined field device by means of the authentication medium or a storage medium, or
transmission of the order ticket to the defined field device via a wireless or wired network.

4. The method of claim 1, comprising the following method step:
logging-in of the service technician to the defined field device by transmitting the order ticket to the defined field device, wherein the access authorization for performing the defined order on the defined field device is contained in the order ticket.

5. The method of claim 1, comprising the following method step:
expiry of the order ticket after the defined work order has been performed once on the defined field device.

6. The method of claim 1, comprising the following method step:
generating a confirmation ticket relating to the performance of the defined order on the defined field device and transmitting a corresponding confirmation ticket to an order management system.

7. The method of claim 1, comprising the following method step:
listing of at least two of the identifiers not mentioned exhaustively below relating to the performance of the defined work order in the confirmation ticket:
reference to the order data of the order ticket or copy of the order data of the order ticket,
unique identifier of the service technician who executed the work order,
documentation of the performed work or documentation of the settings configured on the defined field device, and
time duration for handling the work order.

8. The method of claim 1, comprising the following method step:
cryptographic protection of the order ticket or of the confirmation ticket.
